(19) United States
(12) Patent Application Publication
(10) Pub. No.: US 2006/0168382 A1
(43) Pub. Date: Jul. 27, 2006

(54) Resolving conflicting requests for use of shared resources

(75) Inventors: Robert J. Dugan, Hyde Park, NY (US); Giles R. Frazier, Austin, TX (US)

Correspondence Address: HESLIN ROTHENBERG FARLEY & MESITI P.C., 5 COLUMBIA CIRCLE, ALBANY, NY, 12203, US

(73) Assignee: International Business Machines Corporation, Armonk, NY (US)

(21) Appl. No.: 11/042,486

(22) Filed: Jan. 25, 2005

(51) Int. Cl. G06F 13/14

(52) U.S. Cl. 710/241

(57) ABSTRACT

Requests obtained from multiple components of a communications environment are processed, including simultaneous requests that use a shared resource. Conflicts resulting from simultaneous attempts to initiate operations between components of the communications environment are resolved. The conflicts are resolved using a set of rules that do not introduce significant complexity to the resolving or deterministic unit.

### CROSS-REFERENCE TO RELATED APPLICATION

This application contains subject matter that is related to the subject matter of the following application, which is assigned to the same assignee as this application and hereby incorporated herein by reference in its entirety:

“COMMUNICATING BETWEEN COMMUNICATIONS COMPONENTS HAVING DIFFERING PROTOCOLS ABSENT COMPONENT MODIFICATIONS,” Dugan et al., IBM Docket No. POU920040140US1, Ser. No. ______; filed ______.

### TECHNICAL FIELD

This invention relates, in general, to using shared resources of a communications environment, and in particular, to resolving conflicting requests for use of the shared resources.

### BACKGROUND OF THE INVENTION

In many computing environments, a plurality of entities use one or more of the same resources. These resources are referred to as shared resources. For example, in some environments, a plurality of entities use a shared resource to manage the processing of requests received from the plurality of entities. Since a shared resource is being used by more than one entity to process requests, conflicts arise when multiple entities attempt to use the shared resource simultaneously. In those cases, a determination is made as to which request is to be honored.

Techniques exist for making such a determination. For instance, one technique includes comparing unique identifiers of the entities making the requests to determine which request has priority. This technique is described in Single-Byte Command Code Sets Connection Architecture (SBCON), Document Number ANSI/INCITS 295-1997, 1997 (R 2002), available from International Cornmittee for Information Technology Standards (INCITS), 1250 Eye Street NW, Suite 200, Washington, D.C. 20005, which is hereby incorporated herein by reference in its entirety.

Other techniques also exist. For example, another technique requires each entity to detect if a shared medium is in use before attempting to initiate an operation. If the shared medium is not in use, then the entity needs to arbitrate for its use prior to performing an operation, as described in Fibre Channel Arbitrated Loop (FC-AL-2), Document Number INCITS 332-1999, available from International Committee for Information Technology Standards (INCITS), 1250 Eye Street NW, Suite 200, Washington, D.C. 20005, which is hereby incorporated herein by reference in its entirety.

Although various techniques exist for resolving conflicts, these techniques are complex. For instance, additional operations are required, such as extracting and comparing unique addresses, or checking and arbitrating use of a shared medium. Thus, a need exists for a less complex technique for resolving conflicts. As one example, a need exists for a technique that does not require the extracting and comparing of addresses or the performance of the preliminary operations of checking and arbitrating for a shared medium.

### SUMMARY OF THE INVENTION

The shortcomings of the prior art are overcome and additional advantages are provided through the provision of a method of managing processing of requests in a communications environment. The method includes, for instance, obtaining by a shared resource of the communications environment one request from one component of the communications environment, the one request destined for another component of the communications environment; simultaneously obtaining by the shared resource another request from the another component destined for the one component; and determining by the shared resource whether to process the one request or the another request, the determining being based on a stage of processing by the shared resource of a selected request of the one request and the another request.

In a further aspect of the present invention, a method of managing processing of requests in a communications environment is provided. The method includes, for instance, obtaining a request that is in conflict with an operation, the operation including at least one of another request and a function being performed; and determining whether the request is to be processed, the determining being based on a stage of processing of the operation.

In yet a further aspect of the present invention, a deterministic unit usable in processing requests of a communications environment is provided. The deterministic unit includes, for instance, logic to determine whether a request obtained by the deterministic unit is to be processed, the logic including a set of rules to be used in the determining, the set of rules including, for instance, a first rule indicating that a link-level request initiated by an input/output unit of the communications environment is to unconditionally proceed; a second rule indicating that a request from an input/output driver of the communications environment to an input/output unit of the communications environment is to be unconditionally rejected, in response to a connection to the input/output unit being in existence or pending; and a third rule indicating that a request from an input/output unit of the communications environment to an input/output driver of the communications environment is to be processed, if an indication of a request simultaneously received by the deterministic unit from the input/output driver has not been sent to the input/output unit.

System and computer program products corresponding to the above-summarized methods are also described and claimed herein.

Additional features and advantages are realized through the techniques of the present invention. Other embodiments and aspects of the invention are described in detail herein and are considered a part of the claimed invention.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 depicts one embodiment of a communications environment incorporating and using one or more aspects of the present invention;

FIG. 2 depicts one embodiment of the logic associated with an overview of implementing a plurality of rules to manage processing of requests, in accordance with an aspect of the present invention;

FIG. 3 depicts one embodiment of the logic associated with processing an initiation information unit received from a channel, in accordance with an aspect of the present invention; and

FIG. 4 depicts one embodiment of the logic associated with processing a device-level initiation frame received from a control unit, in accordance with an aspect of the present invention.

### BEST MODE FOR CARRYING OUT THE INVENTION

In accordance with an aspect of the present invention, a capability is provided that facilitates processing of requests obtained from multiple entities or components. As one particular example, a capability is provided for resolving conflicting requests received from multiple components that desire use of one or more shared resources. An example of a shared resource used in one or more aspects of the present invention is a protocol converter that receives requests from multiple components coupled to the protocol converter that have differing communications protocols and wish to communicate with one another. The protocol converter translates communications received by one component and destined for another component from the protocol of the one component to the protocol of the another component. In this particular example, the protocol converter is coupled between a FICON channel and an ESCON control unit offered by International Business Machines Corporation, Armonk, N.Y. However, in other embodiments, the protocol converter may be employed by different components; and/or the conflict resolution technique may be used by components other than a protocol converter.

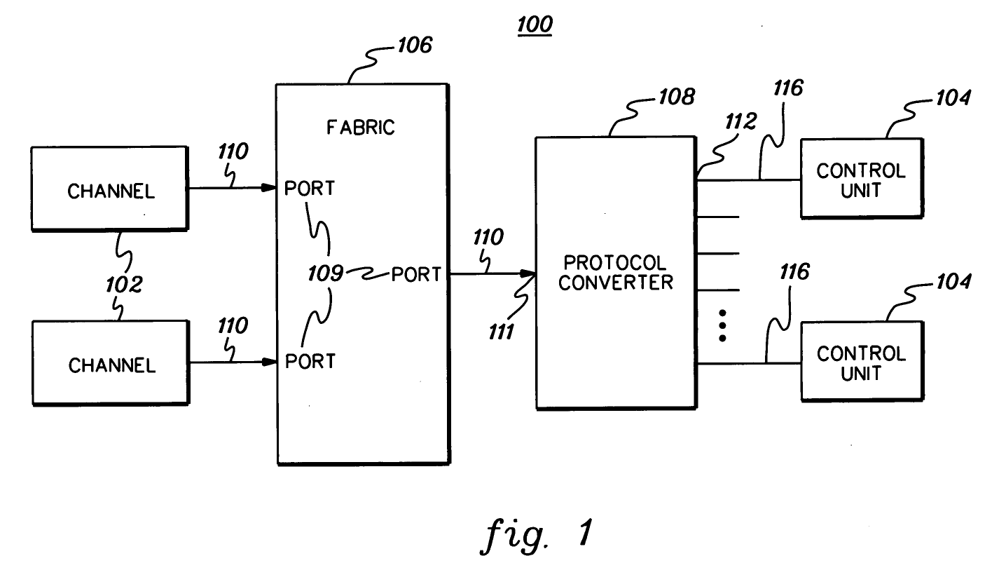

One embodiment of a communications environment incorporating and using one or more aspects of the present invention is depicted in FIG. 1. In this particular example, communication is between input/output drivers (e.g., channels) of one protocol (e.g., FICON) and input/output units (e.g., control units) of another protocol (ESCON). Although the examples described herein are for communications between FICON channels and ESCON control units, these are only examples. One or more aspects of the present invention can be used with other types of channels and/or control units, as well as with other types of components and/or in any application in which conflicts arise.

Referring to FIG. 1, a communications environment 100 includes one or more channels 102 coupled to one or more control units 104 via a fabric 106 and a protocol converter 108. Channels 102 support, for instance, the FICON protocol offered by International Business Machines Corporation, Armonk, N.Y., and control units 104 support, for instance, the ESCON protocol offered by International Business Machines Corporation, Armonk, N.Y.

In one example, each of the FICON channels is assigned, during, for instance, initialization of the configuration of FIG. 1, a three-byte N_Port ID (node port identifier), including a domain byte (dd), an area byte (aa) and a port byte (pp). The procedure for assigning an N_Port ID to a FICON channel is performed using well-known techniques specified in, for example, Fibre Channel-Single-Byte Code Sets Mapping Protocol (FC-SB-3), Document Number ANSI/INCITS 374-2003, available from International Committee for Information Technology Standards (INCITS), 1250 Eye Street NW, Suite 200, Washington, D.C. 20005, and Fibre Channel-Framing and Signaling Interface (FC-FS), Document Number ANSI/INCITS 373, available from International Committee for Information Technology Standards (INCITS), 1250 Eye Street NW, Suite 200, Washington, D.C. 20005, each of which is hereby incorporated herein by reference in its entirety. Typically, each FICON channel is assigned a unique value for the area byte (aa). However, this is not a requirement.

Channels 102 are coupled to fabric 106 via one or more links 110, such as FICON links. Fabric 106 conforms to the requirements specified in Fibre Channel-Single-Byte Code Sets Mapping Protocol (FC-SB-3), Document Number ANSI/INCITS 374-2003, available from International Committee for Information Technology Standards (INCITS), 1250 Eye Street NW, Suite 200, Washington, D.C. 20005, and Fibre Channel-Framing and Signaling Interface (FC-FS), Document Number ANSI/INCITS 373, available from International Committee for Information Technology Standards (INCITS), 1250 Eye Street NW, Suite 200, Washington, D.C. 20005, each of which is hereby incorporated herein by reference in its entirety. Fabric 106 includes a plurality of ports 109 (e.g., fabric ports or F_Ports) and supports N_Port ID virtualization (NPIV), which allows a plurality of port ids to be assigned to one N_Port as described in a U.S. patent application entitled “Method and Apparatus For Obtaining Multiple Port Addresses By A Fibre Channel From A Network Fabric,” Dugan et al., U.S. Patent Application Publication No. 2003/0103405 A1, published Jun. 5, 2003, which is hereby incorporated herein by reference in its entirety.

Fabric 106 is coupled to protocol converter 108 via one or more FICON links 110. Protocol converter 108 includes an N_Port 111, and as with the fabric, it supports N_Port ID virtualization allowing the protocol converter to acquire multiple addresses (N_Port IDs) from the fabric. The protocol converter provides n physical ports 112, each of which can connect to a control unit 104 or other peripheral device via one or more links 116, such as ESCON links, offered by International Business Machines Corporation, Armonk, N.Y.

By employing NPIV, the protocol converter is able to acquire a plurality of N_Port IDs: one N_Port ID for its N_Port and one N_Port ID for each of its physical ESCON ports 112, thus enabling the protocol converter to make each of the control units appear to the channels as if it were a control unit conforming to the protocol of the channel, instead of the protocol of the control unit. This allows the FICON channels to communicate with the ESCON control units, and vice versa, transparently without any modification to the FICON channels nor to the control units. This communication is described in further detail in a co-pending U.S. patent application entitled “Communicating Between Communications Components Having Differing Protocols Absent Component Modifications,” Dugan et al., IBM Docket No. POU920040140US1, Ser. No. ______, filed ______, which is hereby incorporated herein by reference in its entirety.

Connections between FICON channels and ESCON control units can be established via the protocol converter at any time by either a FICON channel or an ESCON control unit. For instance, a channel initiates a connection with a control unit by sending an initiation information unit to the protocol converter requesting a connection to the control unit. An initiation information unit is a FICON information unit, or packet, requesting the establishment of a connection. When the protocol converter receives this initiation information unit, it converts it into an ESCON initiation frame, and sends the initiation frame to the appropriate control unit, which establishes the connection. After the connection is established, normal communications can commence between the channel and the control unit. During these communications, the protocol converter converts FICON frames into ESCON frames containing equivalent information and forwards them to the ESCON control unit, and converts ESCON frames into FICON frames containing equivalent information and forwards them to the FICON channel.

Similarly, a control unit establishes a connection with a channel by sending an initiation frame to the protocol converter requesting a connection with the channel. The protocol converter receives the ESCON initiation frame, converts it into a FICON initiation frame, and sends the FICON initiation frame to the appropriate channel, which establishes the connection. After the connection is established, again, normal communications can commence.

In the case of the control unit initiation frames, there are, for instance, two types of initiation frames: a link-level initiation frame and a device-level initiation frame. A link-level initiation frame sets up the communication parameters, and a device-level initiation frame is used to perform a particular input/output function, such as the transfer of user data. The protocol converter can distinguish between a link-level initiation frame and a device-level initiation frame via, for instance, a flag in the frame.

Since these connections can be established at any time, the connection establishment procedure is to manage the processing of individual requests, including the managing of simultaneous requests from a channel and a control unit. A simultaneous request is, for instance, when a channel sends an initiation request to the protocol converter to initiate a connection with a control unit, and substantially simultaneously, the control unit sends an initiation request to the protocol converter initiating a connection with the same channel (or vice versa). That is, the protocol converter has multiple concurrent requests to be processed for the same set of components. To manage these requests, in accordance with an aspect of the present invention, a capability is provided that includes executing a set of rules to determine whether to allow the control unit's request or the channel's request to proceed.

As one example, the set of rules used to manage the processing of requests includes the following:

Rule 1: If the protocol converter receives a link-level initiation frame from a control unit, it unconditionally sends the corresponding initiation information unit or extended link service to the channel. As used herein, corresponding indicates that the frame (or other unit of information) has been converted into a form understandable by the receiving component, such as the channel in this case.

This rule makes use of the fact that link-level operations can be performed by channels simultaneously with other link-level or device-level operations with the same control unit by allowing the protocol converter to unconditionally send the corresponding frame to the channel, whenever it has received a frame from the control unit initiating a link-level operation. This rule simplifies the protocol converter design considerably, since it narrows the case where simultaneous operations occur to situations in which the protocol converter has received a frame from a control unit initiating a device-level operation.

Rule 2: If a connection exists between a control unit and a channel for a device-level operation, when the protocol converter receives an information unit from any channel initiating a connection with the same control unit, then the protocol converter responds with a logical busy reply (LBY).

This rule allows the protocol converter to unconditionally respond to any initiation information unit from any channel with a logical busy reply, if it receives another information unit from any channel initiating a connection with the same control unit. This simplifies the protocol converter design by allowing it to unconditionally ignore requests (by responding with a logical busy reply) for new connections, while it is processing an existing or pending connection.

Rule 3: If the protocol converter has recognized an initiation information unit from a channel requesting the establishment of a connection to a control unit and a device-level initiation frame from the control unit requesting the establishment of a connection to the same channel (i.e., simultaneous requests), then: if the protocol converter has not yet sent the corresponding initiation frame to the control unit, then the protocol converter sends a logical busy information unit to the channel and it sends the initiation information unit corresponding to the initiation frame received from the control unit to the channel within y ms after sending the logical busy reply. Otherwise, it sends a logical busy reply frame to the control unit.

With this rule, the action taken by the protocol converter depends only on whether or not it has sent the corresponding initiation frame received from the channel to the control unit at the time it recognizes the initiation frame from the control unit. The action does not depend on whether or not the protocol converter has sent the initiation information unit to the channel, nor does it depend on the relative values of the link addresses or unique identifiers of the channel and control unit. This simplification results in a very simple protocol converter design with associated low cost and high performance.

Rule 4: In addition to the above rules, in one embodiment, a channel is to adhere to the following rule in order to avoid unnecessary retries by the channel after having received a logical busy from the protocol converter:

If a channel receives a logical busy in response to an initiation information unit which requests the establishment of a connection to a control unit, then the channel delays x ms (e.g., x=500) before attempting to retry the operation, where x ms is >y ms (e.g., y=200). (See rule III.)

While good design normally dictates delaying some amount of time after having attempted an operation and receiving a busy response, Rule 4 places a lower bound on the delay time in order to allow the protocol converter to send the initiation information unit to the channel before the channel re-tries the operation.

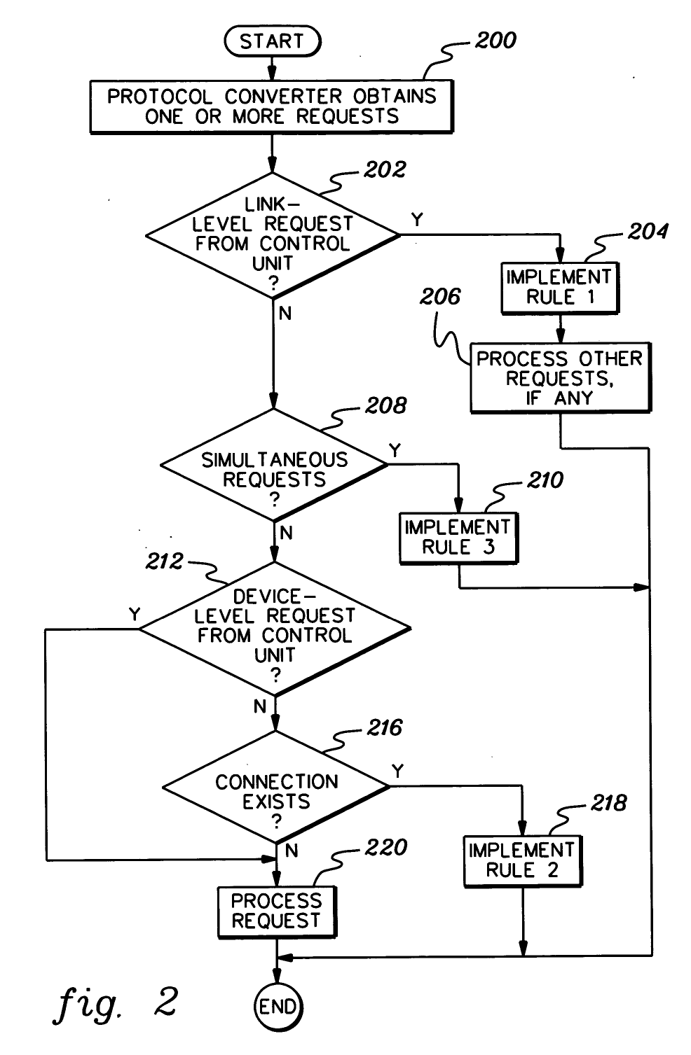

The above rules are used to manage the processing of requests from multiple components. One embodiment of the logic associated with an overview of implementing various of the above rules is described with reference to FIG. 2. In one example, this logic is performed by the protocol converter or another deterministic unit.

Initially, the protocol converter obtains (e.g., receives, is provided, has, etc.) one or more requests, STEP 200. In response to receiving the one or more requests, a determination is made as to whether either of the requests is a link-level initiation request from a control unit, INQUIRY 202. If so, then Rule 1 is implemented, STEP 204. Further, if another request was received concurrently with the link-level request, that request is also processed, STEP 206.

Returning to INQUIRY 202, if none of the requests is a link-level initiation request from the control unit, then a further determination is made as to whether simultaneous requests have been received, INQUIRY 208. A simultaneous request is, for instance, one in which a channel is requesting the establishment of a connection to the control unit and the control unit is requesting establishment of a connection to the same channel for device-level operations. If simultaneous requests have been received, then Rule 3 is implemented, STEP 210. Otherwise, a further determination is made as to whether the request received is a device-level initiation request from the control unit, INQUIRY 212. If it is a device-level initiation request from the control unit, then the request is processed, STEP 220.

However, if the received request is not a request from a control unit, but instead, an initiation request from a channel requesting a connection between the channel and a control unit, then a further determination is made as to whether a connection already exists between another channel and the control unit, INQUIRY 216. Should a connection exist, then Rule 2 is implemented, STEP 218. Otherwise, the received request is processed, STEP 220.

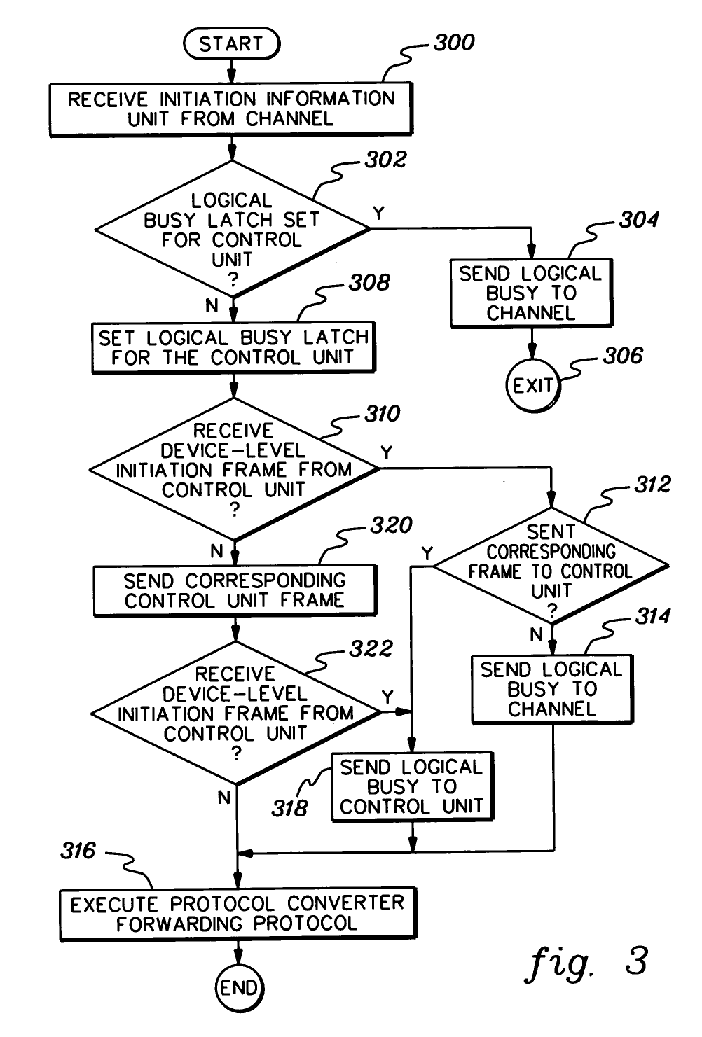

Further details regarding the implementation of Rule 2 and Rule 3 are described with reference to FIG. 3. In this example, the logic is described from the standpoint of receiving an initiation information unit from a channel destined to a control unit. This logic is performed by, for instance, the protocol converter or other deterministic unit.

Referring to FIG. 3, initially, if the protocol converter receives an initiation information unit from a channel destined for a control unit, STEP 300, a determination is made as to whether the logical busy latch is set for the control unit, INQUIRY 302. The logical busy latch is set for a control unit whenever a connection exists or is being initiated from any channel to that control unit. If the latch is set, then a logical busy information unit is sent to the channel in response to the initiation information unit, STEP 304, the initiation information unit is discarded, and processing is complete, STEP 306. This is an implementation of Rule 2.

However, if the latch is not set for the control unit, STEP 302, then the logical busy latch is set, STEP 308, so that if another channel sends an initiation information unit to the control unit, it will be sent a logical busy information unit in response. After this step, the protocol converter prepares to send the control unit frame corresponding to the channel initiation information unit to the control unit.

Up to the point in which the control unit frame is sent, however, if the protocol converter receives a device-level initiation frame from the control unit (i.e., simultaneous requests), INQUIRY 310, then Rule 3 is implemented. As one example, a further determination is made as to whether a frame corresponding to the channel information unit has been sent to the control unit, INQUIRY 312. If not, the protocol converter discards the channel information unit it was preparing to send, if any, and sends a logical busy to the channel, STEP 314. Moreover, the protocol converter begins normal frame processing for the connection, STEP 316. This includes, for instance, executing the protocol converter forwarding protocol, which includes sending to the channel an initiation information unit corresponding to the ESCON initiation frame received from the control unit within y ms after sending the logical busy to the channel.

Returning to INQUIRY 312, if the corresponding frame has been sent to the control unit, then a logical busy frame is sent to the control unit, STEP 318, and processing continues at STEP 316.

Returning to INQUIRY 310, if a device-level initiation frame has not been received from the control unit before the control unit frame corresponding to the channel information unit is sent to the control unit, then the corresponding control unit frame is sent to the control unit, STEP 320. If, after the frame has been sent, a device-level initiation frame is received from the control unit, INQUIRY 322, then a logical busy reply is sent to the control unit, STEP 318. (In one embodiment, this action does not violate ESCON rules for frames passing, since ESCON allows the switch, which in this case is the protocol converter, to reject the initiation frame from the control unit when device-level initiation frames are simultaneously sent.) Further, or if a device-level initiation frame has not been received from the control unit, then the protocol converter forwarding protocol is executed, STEP 316.

The forwarding protocol includes frame processing in which the protocol converter converts frames from the control unit into the corresponding channel frames and sends them to the channel. It also converts channel frames from the channel into the corresponding control unit frames and sends them to the control unit. This processing is further described in co-pending U.S. patent application, entitled “Communicating Between Communications Components Having Differing Protocols Absent Component Modifications,” Dugan et al., IBM Docket No. POU920040140US1, Ser. No. ______, filed ______, which is hereby incorporated herein by reference in its entirety. When the connection is terminated, the protocol converter resets the logical busy latch for the control unit.

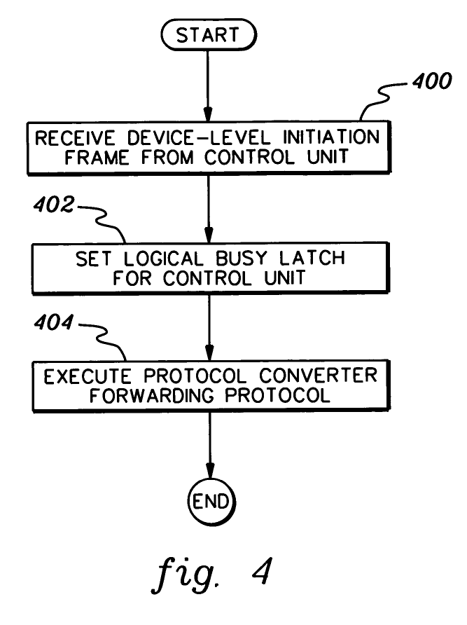

In addition to the logic associated with receiving initiation information units from a channel destined to a control unit, device-level initiation frames may also be received from the control unit and destined for a channel. This logic is described with reference to FIG. 4. Note that this logic does not address link-level initiation frames, since Rule 1 allows link-level initiation frames from the control unit to be processed regardless of existing connections. Further, this logic pertains to the situation in which a device-level initiation information unit is received from a control unit when no connection exists or is being initiated to the control unit. This logic is performed by, for instance, the protocol converter or other deterministic unit.

Referring to FIG. 4, when a device-level initiation frame is received from the control unit and no connection exists or is being initiated to the control unit, STEP 400, the protocol converter sets the logical busy latch for the control unit, STEP 402. The setting of the logical busy latch for the control unit causes initiation information units initiating a connection to the control unit to be discarded until the logical busy latch is reset.

In addition to setting the logical busy latch, the protocol converter executes the forwarding protocol, as described herein, STEP 404. This completes processing.

Described in detail above is a capability for facilitating the processing of requests obtained by a protocol converter or other deterministic unit from multiple components. In particular, a capability is described that facilitates the processing of simultaneous requests received by the deterministic unit from the multiple components. As described herein, one or more rules are used in different situations to determine whether and/or when a specific request is to be processed.

One or more aspects of the present invention advantageously enables conflicts to be resolved in a less complex, less time-consuming, less costly and more productive manner. This allows entities, such as protocol converters and other deterministic units, to be simplified.

Although various examples are described above, these are only examples. Many variations may be provided without departing from the spirit of the present invention. As one example, a communications environment other than the one described herein may benefit from one or more aspects of the present invention. For instance, components other than FICON channels and/or ESCON control units may be used, such as other types of channels and/or control units. Further, input/output (I/O) drivers other than channels may be used. Yet further, input/output units, other than control units, such as I/O devices or other peripheral devices, may be used. Further, other types of components may be used. Many other variations are possible and are included herein.

As a further example, the protocol converter may be included within the fabric, coupled thereto, or a combination thereof. Moreover, deterministic units other than protocol converters may include one or more aspects of the present invention. Any unit, entity, component, application, etc. that needs to manage the processing of requests (referred to herein as a deterministic unit) may include one or more aspects of the present invention.

The capabilities of one or more aspects of the present invention can be implemented in software, firmware, hardware or some combination thereof. Further, deterministic units, other than protocol converters, may benefit from one or more aspects of the present invention.

One or more aspects of the present invention can be included in an article of manufacture (e.g., one or more computer program products) having, for instance, computer usable media. The media has therein, for instance, computer readable program code means or logic (e.g., instructions, code, commands, etc.) to provide and facilitate the capabilities of the present invention. The article of manufacture can be included as a part of a computer system or sold separately.

Additionally, at least one program storage device readable by a machine embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

Although preferred embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims.

What is claimed is:

1. A method of managing processing of requests in a communications environment, said method comprising:
obtaining by a shared resource of the communications environment one request from one component of the communications environment, the one request destined for another component of the communications environment;
simultaneously obtaining by the shared resource another request from the another component destined for the one component; and
determining by the shared resource whether to process the one request or the another request, said determining being based on a stage of processing by the shared resource of a selected request of the one request and the another request.

2. The method of claim 1, wherein the determining is based on one or more rules employed by the shared resource.

3. The method of claim 1, wherein the one request comprises a request by the one component to connect to the another component, and the another request comprises a request by the another component to connect to the one component.

4. The method of claim 3, wherein a component of the one component and the another component comprises an input/output driver and the other component of the one component and the another component comprises an input/output unit.

5. The method of claim 4, wherein the shared resource comprises a protocol converter coupled to the one component and the another component.

6. The method of claim 1, wherein the one component comprises an input/output driver, the another component comprises an input/output unit, and the determining is based on the stage of processing by the shared resource of the one request destined for the input/output unit.

7. The method of claim 6, wherein the determining based on the stage of processing comprises determining whether the shared resource has sent an indication of the one request from the input/output driver to the input/output unit.

8. The method of claim 7, wherein the another request from the input/output unit is processed, in response to the determining indicating that the indication of the one request has not been sent to the input/output unit.

9. The method of claim 8, wherein the indication of the one request comprises the one request translated to a translated request understandable by the input/output unit.

10. The method of claim 8, further comprising retrying the one request after waiting a delay time, the delay time comprising a time to enable the shared resource to send an indication of the another request to the input/output driver, prior to retrying the one request.

11. The method of claim 1, wherein the non-selected request is processed, in response to the determining indicating that an indication of the selected request has not been sent by the shared resource to its intended destination.

12. The method of claim 1, wherein the determining takes into consideration that a request from a chosen component of the one component and the another component is processed, unless an indication of a request from a non-chosen component of the one component and the another component has been sent to the chosen component.

13. A method of managing processing of requests in a communications environment, said method comprising:
obtaining a request that is in conflict with an operation, said operation comprising at least one of another request and a function being performed; and
determining whether the request is to be processed, said determining being based on a stage of processing of the operation.

14. The method of claim 13, wherein the determining is based on one or more rules implemented by a deterministic unit.

15. The method of claim 14, wherein the request is a request from one component of the communications environment destined to another component of the communications environment, and the operation comprises a request from the another component destined for the one component, and wherein the determining is based on the stage of processing by the deterministic unit of the request destined for a selected component of the one component and the another component.

16. The method of claim 14, wherein the request is a request from one component of the communications environment to connect to another component of the communications environment, and the operation comprises an existing connection with the another component, and wherein the determining indicates that the request is not to be processed.

17. A deterministic unit usable in processing requests of a communications environment, said deterministic unit comprising:
logic to determine whether a request obtained by the deterministic unit is to be processed, said logic comprising a set of rules to be used in the determining, said set of rules comprising:
a first rule indicating that a link-level request initiated by an input/output unit of the communications environment is to unconditionally proceed;
a second rule indicating that a request from an input/output driver of the communications environment to an input/output unit of the communications environment is to be unconditionally rejected, in response to a connection to the input/output unit being in existence or pending; and
a third rule indicating that a request from an input/output unit of the communications environment to an input/output driver of the communications environment is to be processed, if an indication of a request simultaneously received by the deterministic unit from the input/output driver has not been sent to the input/output unit.

18. A system of managing processing of requests in a communications environment, said system comprising:
means for obtaining by a shared resource of the communications environment one request from one component of the communications environment, the one request destined for another component of the communications environment;
means for simultaneously obtaining by the shared resource another request from the another component destined for the one component; and
means for determining by the shared resource whether to process the one request or the another request, said means for determining being based on a stage of processing by the shared resource of a selected request of the one request and the another request.

19. The system of claim 18, wherein the determining is based on one or more rules employed by the shared resource.

20. The system of claim 18, wherein the one request comprises a request by the one component to connect to the another component, and the another request comprises a request by the another component to connect to the one component.

21. The system of claim 18, wherein the one component comprises an input/output driver, the another component comprises an input/output unit, and the determining is based on the stage of processing by the shared resource of the one request destined for the input/output unit.

22. The system of claim 21, wherein the means for determining based on the stage of processing comprises means for determining whether the shared resource has sent an indication of the one request from the input/output driver to the input/output unit.

23. The system of claim 22, wherein the another request from the input/output unit is processed, in response to the determining indicating that the indication of the one request has not been sent to the input/output unit.

24. The system of claim 23, wherein the indication of the one request comprises the one request translated to a translated request understandable by the input/output unit.

25. The system of claim 23, further comprising means for retrying the one request after waiting a delay time, the delay time comprising a time to enable the shared resource to send an indication of the another request to the input/output driver, prior to retrying the one request.

26. The system of claim 18, wherein the non-selected request is processed, in response to the means for determining indicating that an indication of the selected request has not been sent by the shared resource to its intended destination.

27. The system of claim 18, wherein the means for determining takes into consideration that a request from a chosen component of the one component and the another component is processed, unless an indication of a request from a non-chosen component of the one component and the another component has been sent to the chosen component.

28. A system of managing processing of requests in a communications environment, said system comprising:
a shared resource of the communications environment to obtain one request from one component of the communications environment, the one request destined for another component of the communications environment;
the shared resource to simultaneously obtain another request from the another component destined for the one component; and
the shared resource to determine whether to process the one request or the another request, the determining being based on a stage of processing by the shared resource of a selected request of the one request and the another request.

29. An article of manufacture comprising:
at least one computer usable medium having computer readable program code logic to manage processing of requests in a communications environment, the computer readable program code logic comprising:
obtain logic to obtain by a shared resource of the communications environment one request from one component of the communications environment, the one request destined for another component of the communications environment;
obtain logic to simultaneously obtain by the shared resource another request from the another component destined for the one component; and
determine logic to determine by the shared resource whether to process the one request or the another request, the determining being based on a stage of processing by the shared resource of a selected request of the one request and the another request.

30. The article of manufacture of claim 29, wherein the determining is based on one or more rules employed by the shared resource.

31. The article of manufacture of claim 30, wherein the one request comprises a request by the one component to connect to the another component, and the another request comprises a request by the another component to connect to the one component.

32. The article of manufacture of claim 29, wherein the one component comprises an input/output driver, the another component comprises an input/output unit, and the determining is based on the stage of processing by the shared resource of the one request destined for the input/output unit.

33. The article of manufacture of claim 32, wherein the determine logic based on the stage of processing comprises logic to determine whether the shared resource has sent an indication of the one request from the input/output driver to the input/output unit.

34. The article of manufacture of claim 33, wherein the another request from the input/output unit is processed, in response to the determine logic indicating that the indication of the one request has not been sent to the input/output unit.

35. The article of manufacture of claim 34, wherein the indication of the one request comprises the one request translated to a translated request understandable by the input/output unit.

36. The article of manufacture of claim 34, further comprising retry logic to retry the one request after waiting a delay time, the delay time comprising a time to enable the shared resource to send an indication of the another request to the input/output driver, prior to retrying the one request.

37. The article of manufacture of claim 29, wherein the non-selected request is processed, in response to the determine logic indicating that an indication of the selected request has not been sent by the shared resource to its intended destination.

38. The article of manufacture of claim 29, wherein the determine logic takes into consideration that a request from a chosen component of the one component and the another component is processed, unless an indication of a request from a non-chosen component of the one component and the another component has been sent to the chosen component.
